(19) United States
(12) Patent Application Publication
(10) Pub. No.: US 2009/0213621 A1
(43) Pub. Date: Aug. 27, 2009

(54) LUMINAIRE PROFILE

(76) Inventor: Andreas HIERZER, Graz (AT)

Correspondence Address: Workman Nydegger;1000 Eagle Gate Tower, 60 East South Temple, Salt Lake City, UT, 84111, US

(21) Appl. No.: 12/389,965

(22) Filed: Feb. 20, 2009

(30) Foreign Application Priority Data
Feb. 22, 2008 (AT) A 294/2008

(51) Int. Cl. H01R 33/00

(52) U.S. Cl. 362/656

(57) ABSTRACT

A luminaire profile comprises a hollow basic profile and an illuminant profile insertable in said basic profile via a snap-in connection. Concave supports are formed on opposite insides of the basic profile and convex supports are formed on the illuminant profile which correspond to the concave supports of the basic profile, with the concave supports and/or the convex supports—viewed in the cross-sectional direction—following a radius (R).

The invention relates to a luminaire profile comprising a hollow basic profile and an illuminant profile insertable in said basic profile via a snap-in connection.

A problem arising again and again in illumination technology is that a luminaire is required which is capable of illuminating areas across a relatively long longitundinal extension, whereby often the additional desire exists to be able to incorporate such a luminaire in walls, ceilings or pieces of furniture in a flush or embedded manner. However, particularly the latter desire raises the question of accessibility of the luminaire for replacement and maintenance works. Previous luminaire systems have not been able to sufficiently meet those requirements.

A further problem of known luminaires which can be pieced together is that the inserts are no longer located in a defined position after they have been plugged into a basic module, whereby an unsightly optical impression is created and sometimes the operativeness of the luminaires is impaired as well. In any case, positive connections between a basic module and illuminant inserts as provided in prior art luminaires allow no more changes in the position or orientation of the illuminants. In many cases, however, it would be desirable if the orientation of illuminants arranged in an insert could still be changed even after said insert has been plugged into a basic module.

Therefore, the need for a luminaire which is able to meet the above-defined requirements to complete satisfaction still exists.

The present invention solves this problem by providing a luminaire profile comprising a hollow basic profile and an illuminant profile insertable in said basic profile via a snap-in connection, wherein concave supports are formed on opposite insides of the basic profile and convex supports are formed on the illuminant profile which correspond to the concave supports of the basic profile, with the concave supports and/or the convex supports—viewed in the cross-sectional direction—following a radius. The illuminants are arranged in the illuminant profile. During assembly, at first only the basic profile is fastened to or in the foundation, for example by screwing, and the required electrical connections to a power grid are established. Subsequently, the illuminant profile can be inserted into the basic profile and kept there merely by “latching” due to the snap-in connection which is provided. Since at least one group of convex supports and concave supports follows a radius, “latching” is possible with a small expenditure of force, wherein, in the latched state, a defined position of the illuminant profile is still provided in the basic profile. Moreover, in a number of embodiments of the invention, an adjustment of the illuminant profile by twisting it around the longitudinal axis is possible due to the radius as provided, whereby, depending on the dimensioning and shape of the profiles, twistability for dozens of degrees can be achieved, as will be explained further below.

For replacement, the illuminant profile is extracted from the basic profile manually, optionally while being supported by a flat screwdriver or the like. Because of this construction, any expenditure for maintenance is absent. Furthermore, for maintenance, the luminaire profile according to the invention must be accessible only from the front and can therefore be installed in almost all positions.

A very secure fit of the illuminant profile in the basic profile is achieved if the convex supports and the concave supports exhibit curved surfaces, in particular cylinder surfaces, corresponding to each other. As the case may be, simplified producibility of the profile is achieved if either the convex supports or the concave supports are implemented by longitudinal webs, with the individual webs being offset relative to each other such that they follow a radius.

Uniform illumination across the length of the luminaire profile is achieved if a plurality of illuminants, preferably light emitting diodes, are arranged in the illuminant profile and are distributed across the length thereof Light emitting diodes provide high luminosity, combined with low power consumption and a small overall size, and can therefore be used particularly advantageously.

In order to permit flush installation of the luminaire profile in a foundation such as a wall or ceiling, in one embodiment of the invention, it is provided that the illuminants are inserted in a recessed manner in the illuminant profile, wherein optionally a transparent cover is arranged over the illuminants. The transparent cover causes uniform irradiation of light and may be attached to the illuminant profile or to the basic profile. The cover can also assume further functions, in particular, it may serve as an optical anti-blinding and/or filtering device as well as a mechanical dust shield and a protection against contact, respectively, and as a device for preventing displacement by unauthorized individuals.

In order that the irradiation of light of the luminaire profile is variably adjustable, in a further embodiment of the invention, it is provided that the illuminants are pivotably arranged on the illuminant profile, with the illuminants preferably being attached to the illuminant profile via ball-and-socket joints. In this manner, a possibility of individually adjusting the illuminants is obtained.

In order that several luminaire profiles can be combined directly adjacent to each other into a light system of any length, in a further embodiment of the invention, it is provided that electrical plug-and-socket connectors are arranged at the ends of the basic profile for a serial electrical connection to adjacent basic profiles.

In order to save the mechanic the trouble of cabling works, in one variant of the luminaire profile according to the invention, busbars are arranged on the inside of the basic profile, which are in an electrically conductive contact with current collectors on the outside of the illuminant profile as soon as the illuminant profile is inserted into the basic profile.

In a version of the luminaire profile according to the invention which can be incorporated in a versatile, particularly, however, in an embedded manner, the basic profile has a U-shaped cross-section.

In a sophisticated embodiment of the luminaire profile according to the invention, the basic profile has a round cross-section, in particular a circular or elliptical cross-section, with a longitudinal recess running along the length of the basic profile. The illuminant profile is inserted into the longitudinal recess.

In a further embodiment of the luminaire profile according to the invention, which is excellently suitable for being arranged at the edges of rooms or pieces of furniture, the basic profile has a rectangular cross-section, with a longitudinal recess running along the length of the basic profile in a sidewall or across an edge. The illuminant profile is inserted into the longitudinal recess.

In order that the illuminant profile can be kept in the basic profile so as to be twistable around its longitudinal axis, in one embodiment of the luminaire profile according to the invention, it is provided that the illuminant profile has a circular cross-section. The outer surface of the illuminant profile, which outer surface is bent in a convex manner, forms the convex supports of the snap-in connection interacting with the concave supports on the basic profile.

In a simple form of a luminaire profile according to the invention, the illuminant profile has a rectangular cross-section.

The invention is now illustrated in further detail by way of non-limiting exemplary embodiments with reference to the drawings. In the drawings:

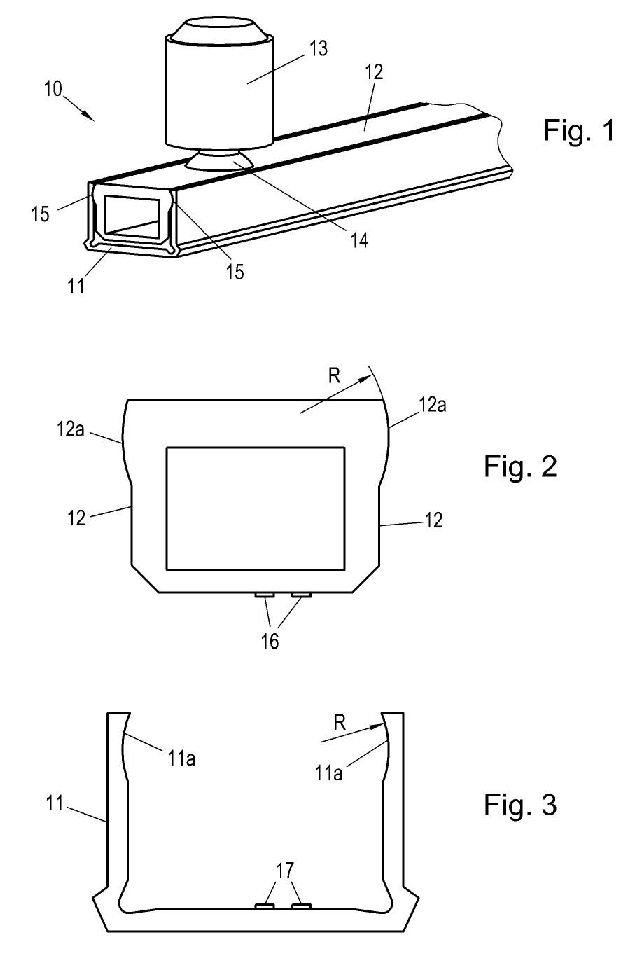

FIG. 1 shows a first embodiment of a luminaire profile according to the invention in perspective view;

FIG. 2 shows a first illuminant profile in section;

FIG. 3 shows a first basic profile in section;

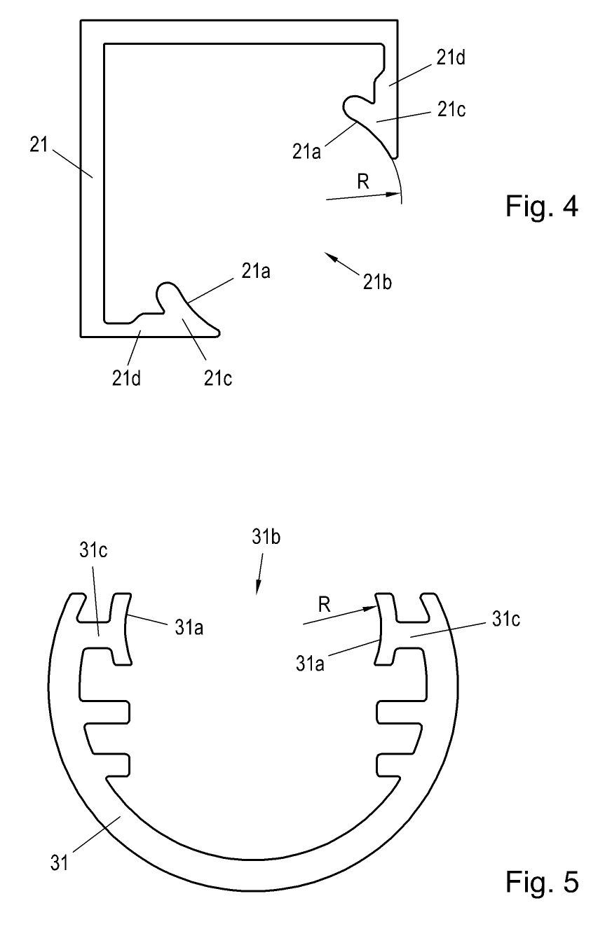

FIG. 4 shows a second basic profile in section;

FIG. 5 shows a third basic profile in section;

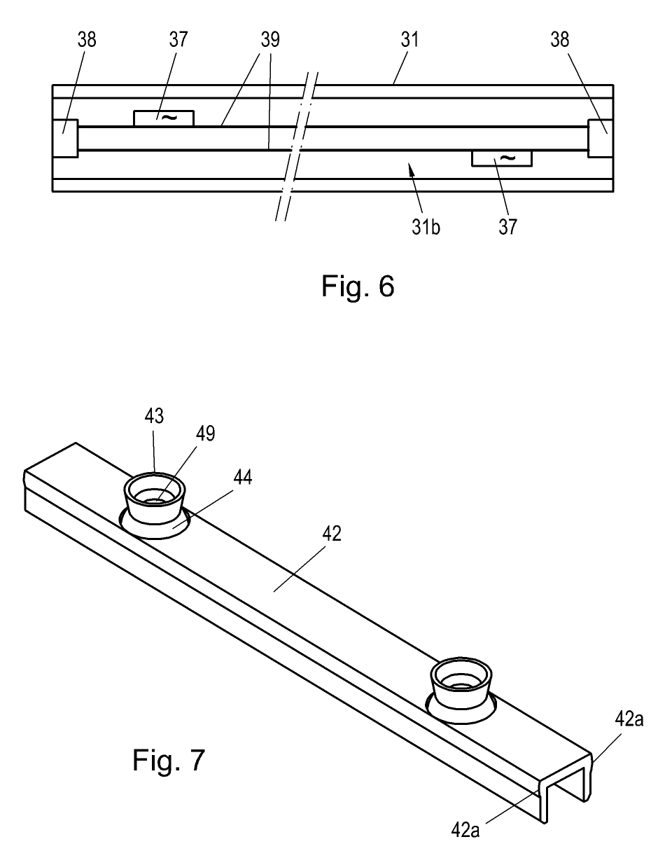

FIG. 6 shows the third basic profile in a schematic top view;

FIG. 7 shows a second illuminant profile in perspective view;

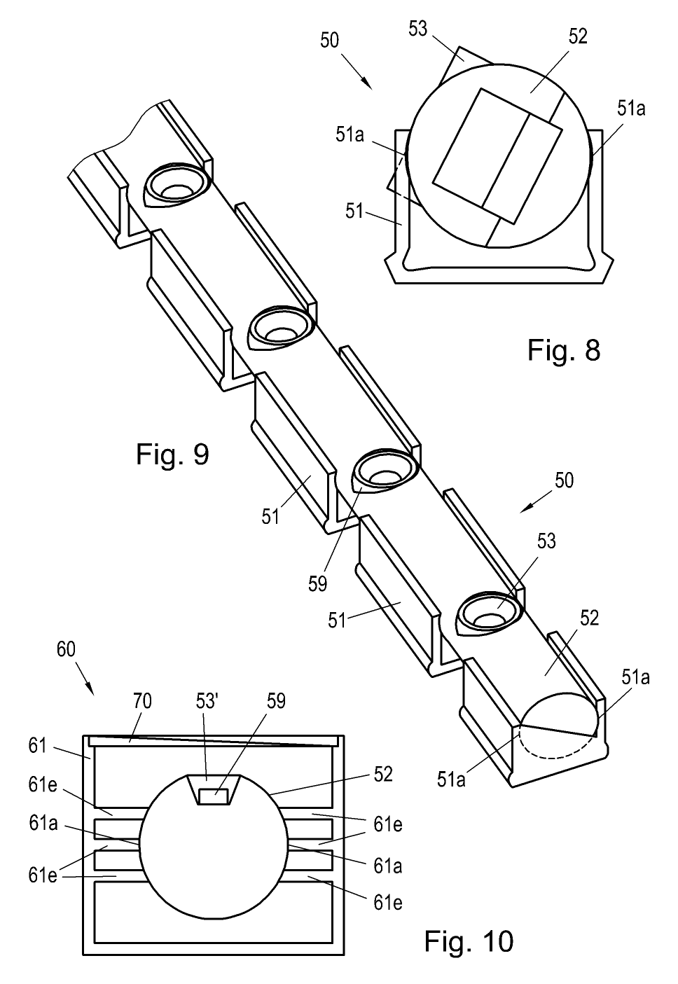

FIG. 8 and FIG. 9 shows a second embodiment of a luminaire profile according to the invention in front view and in perspective view; and

FIG. 10 shows a third embodiment of a luminaire profile according to the invention in section.

FIG. 1 shows a first embodiment of a luminaire profile 10 according to the invention in perspective view. The luminaire profile 10 comprises a hollow U-shaped basic profile 11 into which an illuminant profile 12 with a rectangular cross-section is inserted, with the illuminant profile 12 being releasably secured in the basic profile 11 via snap-in connections 15, 15. The illuminant profile 12 comprises spaced-apart cylindrical emitters 13 (only one is illustrated in the drawing) in which one illuminant is arranged in each case. The emitters 13 are attached to the illuminant profile 12 via ball-and-socket joints 14, whereby they are pivotable. The snap-in connections 15 between the basic profile 11 and the illuminant profile 12 are comprehensible on the basis of the cross-sectional views of the basic profile 11, see FIG. 3, and of the illuminant profile 12, see FIG. 2. On two opposite outsides, the illuminant profile 12 depicted in FIG. 2 comprises convex supports 12a, 12a extending across the length of the illuminant profile as partially cylindrical supporting surfaces, e.g., with a radius R of 7.5 mm. Said convex supports 12a, 12a correspond to concave supports 11a, 11a on two opposite insides of the basic profile 11, as can be seen in FIG. 3. The concave supports 11a, 11a are likewise designed as partially cylindrical supporting surfaces with a radius R of 7.5 mm. The basic profile 11 and the illuminant profile 12 are extruded profiles from a metal or a metal alloy, for example, based on Al. During assembly, at first the basic profile 11 is attached to any desired foundation and thereupon the illuminant profile 12 is either pushed in linearly from one end or is inserted into the basic profile 11 through the recess and pressed inwards. In doing so, the illuminant profile 12 at first slides into the interior of the basic profile 11 until the convex supports 12a, 12a touch the upper edges of the U-legs of the basic profile 11. By applying gentle pressure to the illuminant profile 12, the U-legs of the basic profile are pressed apart resiliently by the convex supports 12a, 12a until the convex supports 12a, 12a enter into the concave supports 11a, 11a of the basic profile 11, whereupon the U-legs of the basic profile elastically move back to their original positions and the convex supports 12a, 12a of the illuminant profile 12 are retained in the concave supports 11a, 11a in a defined position. By extracting the illuminant profile 12 from the basic profile 11, the snap-in connection 15 is releasable again. Reference numeral 16 in FIG. 2 denotes two current collectors the geometrical position of which corresponds to busbars 17 on the inside of the base leg of the basic profile 11 (see FIG. 3). As is evident in particular from FIG. 1, the basic profile 11 and the illuminant profile 12 of the luminaire profile 10 are dimensioned such that, in the assembled state, only a small clearance exists between the two profiles, which is why essentially no twistability of the illuminant profile 12 exists. However, this is not necessary here, since the direction of the irradiation of light is alterable selectively and randomly due to the emitters 13 arranged in an articulated manner. It should be mentioned that the shape of the emitters 13 is in no way limited to the illustrated cylindrical shape.

FIG. 4 shows an alternative embodiment of a basic profile 21 in section. The basic profile 21 exhibits a basically square cross-section, with a longitudinal recess 21b running along the length of the basic profile 21 across an edge. Lugs 21c, 21c are arranged at the cut edges of the sides 21d, 21d of the basic profile 21, in which lugs one concave support 21a, 21a is formed in each case, which supports are designed here as partially cylindrical surfaces with a radius R of 7.5 mm. The distance of the concave supports 21a, 21a from each other is chosen such that, for example, the illuminant profile 12 from FIG. 2 can be latched into the basic profile 21, whereby the convex supports 12a, 12a of the illuminant profile 12 form a snap-in connection with the concave supports 21a, 21a of the basic profile 21.

FIG. 5 shows in section an embodiment of a basic profile 31 having a hollow, round cross-section. A longitudinal recess 31b runs along the length of the basic profile 31 so that said profile generally forms a cylinder open on the side. Lugs 31c, 31c are arranged at the longitudinal edges of the basic profile 31, in which lugs one concave support 31a, 31a is formed in each case, which supports are designed here as partially cylindrical surfaces with a radius R of 7.5 mm. The distance of the concave supports 31a, 31a from each other is chosen such that, for example, the illuminant profile 12 from FIG. 2 can be latched into the basic profile 31, whereby the convex supports 12a, 12a of the illuminant profile 12 form a snap-in connection with the concave supports 31a, 31a of the basic profile 31.

FIG. 6 shows the basic profile 31 from FIG. 5 in a schematic top view of the longitudinal recess 31b. At the bottom of the basic profile 31, schematically illustrated busbars 37 are visible which are connected to cables 39 running longitudinally through the basic profile 31 and ending in plugs 38 at both ends of the basic profile 31, the plugs 38 being connectable to plugs of adjacent basic profiles. The busbars 37 are arranged such that, even if an inserted illuminant profile is twisted, the current collectors thereof are still in electrical contact with the busbars 37.

FIG. 7 shows a U-shaped illuminant profile 42 in perspective view, with emitters 43 being attached to the base thereof via ball-and-socket joints 44. Illuminants 49 in the shape of light emitting diodes are located in the emitters 43. Convex supports 42a, 42a are formed at the legs of the illuminant profile 42, which convex supports may enter into a snap-in connection with concave supports of a matching basic profile.

FIG. 8 and FIG. 9 show a further embodiment of a luminaire profile 50 according to the invention in front view and in perspective view, respectively. Said luminaire profile exhibits a plurality of U-shaped basic profiles 51 arranged in-line and a cylindrical illuminant profile 52 inserted therein. The cylindrical outer wall of the illuminant profile 52 thereby forms convex supports which are locked into the oppositely located concave supports 51a, 51a of the basic profiles 51. The concave supports 51a, 51a of the basic profiles 51 are designed such that the cylindrical illuminant profile 52 is rotatable about its longitudinal axis in the basic profiles 51 so that the direction of the irradiation of light of illuminants 59 arranged in emitters 53 in the illuminant profile 52 is adjustable transversely to the longitudinal axis of the illuminant profile 52. FIGS. 8 and 9 show different rotational positions of the illuminant profile.

FIG. 10 shows a further embodiment of a luminaire profile 60 according to the invention in section, which is similar to the luminaire profile 50 shown in FIGS. 8 and 9 and, in particular, uses the same illuminant profile 52, but with emitters 53′ embedded in a flush manner. However, the U-shaped basic profile 61 used differs from previous embodiments in that the oppositely located concave supports 61a, 61a are, in each case, implemented by three longitudinal webs 61 e which are offset relative to each other such that—viewed in the cross-sectional direction—they follow a radius, more precisely the radius of the cylindrical illuminant profile 52. Due to the flush embedding of the emitters 53′, it is possible to place a transparent cover 70 over the basic profile 61 in order to render the irradiation of light uniform.

It should be mentioned that all basic profiles that have been presented can be arbitrarily combined with all illuminant profiles so that an extremely versatile system of luminaire profiles is created.

1. A luminaire profile comprising:
a hollow basic profile; and
an illuminant profile insertable in said basic profile via a snap-in connection, wherein:
concave supports are formed on opposite insides of the basic profile; and
convex supports are formed on the illuminant profile which correspond to the concave supports of the basic profile, with the concave supports and/or the convex supports—viewed in the cross-sectional direction—following a radius (R).

2. A luminaire profile according to claim 1, wherein the convex supports and the concave supports, respectively, comprise curved surfaces and/or longitudinal webs.

3. A luminaire profile according to claim 1, wherein a plurality of illuminants are arranged in the illuminant profile and are distributed across the length thereof.

4. A luminaire profile according to claim 3, wherein the plurality of illuminants comprise light emitting diodes.

5. A luminaire profile according to claim 1, wherein the illuminants are inserted in a recessed manner in the illuminant profile.

6. A luminaire profile according to claim 5, wherein a transparent cover is arranged over the illuminants.

7. A luminaire profile according to claim 1, wherein the illuminants are pivotably arranged on the illuminant profile.

8. A luminaire profile according to claim 7, wherein the illuminants are attached to the illuminant profile via ball-and-socket joints.

9. A luminaire profile according to claim 1, wherein electrical plug-and-socket connectors are arranged at the ends of the basic profile for a serial electrical connection to adjacent basic profiles.

10. A luminaire profile according to claim 1, wherein busbars are arranged on the inside of the basic profile, which can be brought into an electrically conductive contact with current collectors on the outside of the illuminant profile.

11. A luminaire profile according to claim 1, wherein the basic profile has a U-shaped cross-section.

12. A luminaire profile according to claim 1, wherein the basic profile has a circular cross-section, with a longitudinal recess running along the length of the basic profile.

13. A luminaire profile according to claim 1, wherein the basic profile has an elliptical cross-section, with a longitudinal recess running along the length of the basic profile.

14. A luminaire profile according to claim 1, wherein the basic profile has a rectangular cross-section, with a longitudinal recess running along the length of the basic profile in a sidewall or across an edge.

15. A luminaire profile according to claim 1, wherein the illuminant profile has a circular cross-section.

16. A luminaire profile according to claim 1, wherein the illuminant profile has a rectangular cross-section.
